(19) United States
(12) Patent Application Publication
(10) Pub. No.: US 2025/0363728 A1
(43) Pub. Date: Nov. 27, 2025

(54) IMAGE SYNTHESIS METHOD AND RELATED APPARATUS

(71) Applicant: MASHANG CONSUMER FINANCE CO., LTD., Chongqing (CN)

(72) Inventor: Zhiling YE, Chongqing (CN)

(21) Appl. No.: 19/076,863

(22) Filed: Mar. 11, 2025

(30) Foreign Application Priority Data
May 21, 2024 (CN) 202410635606.6

(51) Int. Cl. G06T 15/20; G06T 7/246; G06T 7/73; G06T 7/90; G06T 15/06; G06T 15/50

(52) U.S. Cl. CPC G06T 15/20; G06T 7/248; G06T 7/74; G06T 7/90; G06T 15/06; G06T 15/506; G06T 2200/08; G06T 2207/10024; G06T 2207/20084; G06T 2207/30204; G06T 2207/30244

(57) ABSTRACT

In an image synthesis method, one or more landmarks of a target image are determined. The one or more landmarks are processed to obtain a spatial structure feature of each of the one or more landmarks. A sampling point is determined based on a position of an image capture device and a pixel in a preview of the target image provided by the image capture device. A position feature of the sampling point is determined. An audio signal is mapped to the one or more landmarks of the target image. A synthetic image of the target image is generated according to the spatial structure feature of (i) the one or more landmarks, (ii) the audio signal, and (iii) the position feature of the sampling point.

### RELATED APPLICATION

The present application claims priority to Chinese Patent Application No. 202410635606.6 filed on May 21, 2024 which is hereby incorporated by reference in its entirety.

### FIELD OF THE TECHNOLOGY

This disclosure relates to the field of image synthesis technologies, including to an image synthesis method and a related apparatus.

### BACKGROUND OF THE DISCLOSURE

With continuous development of image synthesis technologies, various fields have increasing requirements on synthetic images (e.g., synthesis images). In addition, some fields have higher and higher requirements on quality of the synthetic images. In an example, for synthesizing face images, in scenarios such as virtual digital human and digital robots, to pursue a realistic human-computer interaction effect, the requirements on synthesizing face images or synthesizing person images are usually higher. Therefore, synthesizing a high-quality synthetic image of a face or a person becomes one of the hot problems in current research.

### SUMMARY

Aspects of this disclosure provide an image synthesis method and a related apparatus.

In an aspect of this disclosure, an image synthesis method is provided, In the method, one or more landmarks of a target image are determined. The one or more landmarks are processed to obtain a spatial structure feature of each of the one or more landmarks. A sampling point is determined based on a position of an image capture device and a pixel in a preview of the target image provided by the image capture device. A position feature of the sampling point is determined. An audio signal is mapped to the one or more landmarks of the target image. A synthetic image of the target image is generated according to the spatial structure feature of (i) the one or more landmarks, (ii) the audio signal, and (iii) the position feature of the sampling point.

In an embodiment of this disclosure, spatial structure encoding is performed by directly using the spatial structure of a landmark of the target part as an encoding object without an additional feature extraction operation such as smoothing or compression, to avoid loss of information of the target part and to achieve lossless encoding, so that accuracy and completeness of a spatial structure control feature of the landmark can be improved. Further, the spatial structure feature of the landmark is configured for obtaining the synthetic image of the target part, thereby improving fidelity of the synthetic image.

According to an aspect of this disclosure, an image synthesis apparatus including processing circuitry is provided. The processing circuitry is configured to determine one or more landmarks of a target image. The processing circuitry is configured to process the one or more landmarks to obtain a spatial structure feature of each of the one or more landmarks. The processing circuitry is configured to determine a sampling point based on a position of an image capture device and a pixel in a preview of the target image provided by the image capture device. The processing circuitry is configured to determine a position feature of the sampling point. The processing circuitry is configured to map an audio signal to the one or more landmarks of the target image. The processing circuitry is configured to generate a synthetic image of the target image according to the spatial structure feature of (i) each of the one or more landmarks, (ii) the audio signal, and (iii) the position feature of the sampling point.

An aspect of this disclosure provides an electronic device, including a memory and at least one processor. The memory is configured to store program instructions, and the processor is configured to execute the program instructions in the memory to perform any of the image synthesis methods according to this disclosure.

An aspect of this disclosure provides a non-transitory computer readable storage medium. The non-transitory computer-readable storage medium stores a computer program which when executed by a processor, cause the processor to perform any of the image synthesis methods according to this disclosure.

An aspect of this disclosure provides a computer program product. The computer program product includes instructions, and the instructions, when executed by a computer, implement any of the image synthesis methods according to this disclosure.

Embodiments of this disclosure provide an image synthesis method and a related apparatus. A landmark of a target part (e.g., a target image) is determined, and spatial structure encoding is performed on the landmark to obtain a spatial structure feature of the landmark; a sampling point is determined based on a target pose of a photographing device and a pixel in a preview image presented by the photographing device, and a position feature of the sampling point is determined; and further, a synthetic image of the target part is obtained according to the spatial structure feature of the landmark and the position feature of the sampling point. In this disclosure, spatial structure encoding is performed by directly using the spatial structure of the landmark of the target part as an encoding object without an additional feature extraction operation such as smoothing or compression, to avoid loss of information of the target part and to achieve lossless encoding, so that accuracy and completeness of a spatial structure control feature of the landmark can be improved. Further, the spatial structure feature of the landmark is configured for generating the synthetic image of the target part, thereby improving fidelity of the synthetic image.

### BRIEF DESCRIPTION OF THE DRAWINGS

The following briefly introduces the drawings for describing aspects of this disclosure. The drawings in the following description are some examples of this disclosure.

FIG. 1 is a schematic diagram of an example of synthesizing an image based on a NeRF technology.

FIG. 2 is a schematic diagram of an example of synthesizing an audio-driven 3D implicit head image based on NeRF.

FIG. 3 is a schematic diagram of a scenario of an image synthesis method according to an aspect of this disclosure.

FIG. 4 is a schematic flowchart of an image synthesis method according to an aspect of this disclosure.

FIG. 5 is a schematic diagram of performing hash encoding on a landmark by using a landmark grid encoder according to an aspect of this disclosure.

FIG. 6 is a schematic diagram of determining a sampling point according to an aspect of this disclosure.

FIG. 7 is a schematic diagram of extracting a spatial structure feature of a landmark based on a 2D landmark according to an aspect of this disclosure.

FIG. 8 is a schematic flowchart of an image synthesis method according to an aspect of this disclosure.

FIG. 9 is a flowchart of a mode of obtaining a position feature of a sampling point according to an aspect of this disclosure.

FIG. 10 is a flowchart of a NeRF model training method according to an aspect of this disclosure.

FIG. 11 is a schematic structural diagram of an image synthesis apparatus according to an aspect of this disclosure.

FIG. 12 is a schematic structural diagram of an electronic device according to an aspect of this disclosure.

### DETAILED DESCRIPTION

Examples of technical solutions in embodiments of this disclosure are described in the following with reference to the drawings. The described embodiments are merely some of the aspects of this disclosure. Other aspects within the scope of this disclosure.

Terms involved in this disclosure will be briefly introduced as below first. The descriptions of the terms are provided as examples only and are not intended to limit the scope of the disclosure.

Nerve radiation fields (NeRF for short): The NeRF is a deep learning model, and is applied to three-dimensional (3D) implicit space modeling.

Multi-layer perceptron (MLP for short): The MLP is a deep neural network structure, including a plurality of fully-connected neural layers, and is configured to solve various machine learning tasks.

Audio feature extractor (AFE for short): The AFE is configured to extract useful information or features from an audio signal. These features are usually configured for various audio processing tasks such as audio recognition, audio synthesis, speaker recognition, and emotion analysis.

Terms “first,” “second,” and the like in the specification, claims, and the above drawings in this disclosure are configured for distinguishing similar objects instead of describing a specific order or sequence. Data used in such a way may be exchanged under appropriate conditions, so that the embodiments of this disclosure described here can be implemented in order other than the order graphically shown or described here. In addition, terms “include,” “have,” and any other variant thereof are intended to cover a non-exclusive inclusion. For example, a process, method, system, product, or device that includes a series of operations or units is not necessarily limited to those operations or units that are expressly listed, but may include other operations or units that are not expressly listed or are inherent to the process, method, product, or device.

Terms “and/or” used herein is an association relationship for describing associated objects and represents that three relationships may exist. For example, A and/or B may represent the following three cases: only A exists, both A and B exist, and only B exists. “/” indicates an “and” or “or” relationship.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Currently, the NeRF has attracted a large amount of attention in the field of three-dimensional (3D for short) view synthesis, and a large amount of research based on the NeRF technology appears in the field of audio-driven image synthesis.

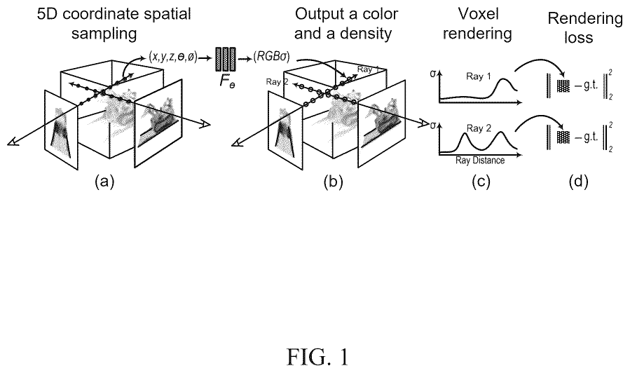

Image synthesis is performed based on the NeRF technology, and an image synthesis principle is shown in FIG. 1. FIG. 1 is a schematic diagram of a principle of synthesizing an image based on a NeRF technology. As shown in (a) in FIG. 1, the NeRF performs spatial sampling through a five-dimensional (5D for short) coordinates of a camera ray to obtain a ray position (x, y, z) and an observation viewpoint direction (θ, φ). As shown in (b) in FIG. 1, the ray position (x, y, z) and the observation viewpoint direction (θ, φ) are input to an MLP (Fθ) to output a color (RGB) and a volume density (σ) of the ray position (x, y, z) in the current observation viewpoint direction (θ, φ). As shown in (c) in FIG. 1, color (RGB) values and volume density (σ) values at each of the ray positions corresponding to the rays are synthesized into an image by using volume rendering. Because a rendering function is differentiable, as shown in (d) in FIG. 1, a NeRF scenario represents that the MLP may be optimized by minimizing a residual between a synthetic image and a real observation image.

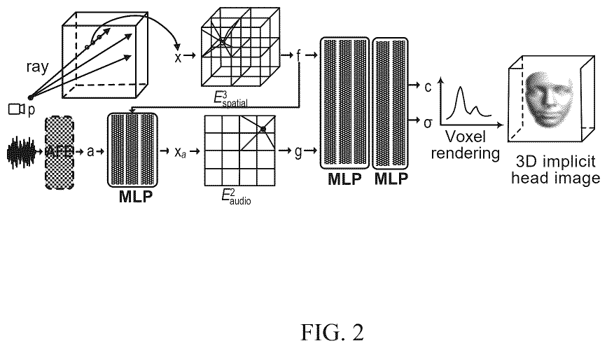

In a related technology, image synthesis is performed based on the NeRF technology. FIG. 2 is a schematic diagram of synthesizing an audio-driven 3D implicit head image based on NeRF. As shown in FIG. 2, sampling is performed in 3D space according to a target pose of a photographing device, that is, a camera, and a ray corresponding to a pixel in a preview image presented by the photographing device to obtain a sampling point x, and further, the sampling point x is encoded through a tri-plane hash encoder or a 3D grid hash encoding to obtain a position feature f corresponding to the sampling point x. An audio signal, that is, audio, is input to the AFE for performing audio feature extraction to obtain an audio feature a of the audio signal output by the AFE. Then, the audio feature a and the position feature f are concatenated and are input to an MLP in an NeRF model for performing spatial-audio perceptual feature extraction to obtain a spatial-audio perceptual feature xₐ of the foregoing audio signal output by the MLP. Further, hash encoding is performed on the spatial-audio perceptual feature xₐ through a two-dimensional hash encoder (E2) to obtain a spatial structure feature feature g. Subsequently, the spatial structure feature g and the foregoing position feature f are concatenated and are input to the MLP for processing to obtain a pixel color and a pixel density corresponding to each spatial position in a to-be-synthesized image. Then, voxel rendering is performed based on the pixel color and the pixel density to obtain the foregoing audio signal-driven synthetic 3D implicit head image.

However, in the foregoing image synthesis based on the NeRF technology, on one hand, once a parameter of an MLP network configured to extract the spatial-audio perceptual feature is fixed, an apparent shortcoming is presented in terms of inputting audio or landmarks generalized out of a training set. For example, when audio/landmarks of different languages or different genders are processed, because data distributions of these audio/landmarks and the training set may be significantly different, it is difficult for an MLP model with a fixed parameter to effectively adapt to these changes, resulting in a relatively poor synthesis effect in an application scenario. On the other hand, when audio feature extraction is performed on the audio by using the AFE, a problem of information loss may occur, resulting in a relatively poor effect of a synthetic image.

Based on the foregoing problem, embodiments of this disclosure provide an image synthesis method and related apparatus. A landmark of a target part is determined, a spatial structure of the landmark is encoded to obtain a spatial structure feature of the landmark, and further, a synthetic image of the target part is obtained based on the spatial structure feature of the landmark and a position feature of a sampling point, thereby improving fidelity of the synthetic image.

Next, the image synthesis method is described in further detail with reference to specific embodiments.

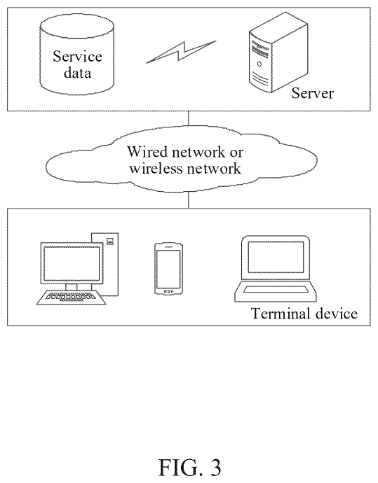

FIG. 3 is a schematic diagram of a scenario of an image synthesis method according to an embodiment of this disclosure. As shown in FIG. 3, the scenario includes: a terminal device.

The terminal device may be referred to as user equipment (UE for short), a mobile station (MS for short), a mobile terminal, a terminal, and the like. In an application, the terminal device is, for example: a desktop computer, a notebook computer, and a personal digital assistant (PDA for short), a smartphone, a tablet computer, an in-vehicle device, a wearable device (such as a smartwatch or a smart bracelet), a smart household device (such as a smart display device), and the like.

For example, the terminal device may process a landmark of a target part by the image synthesis method provided in this embodiment of this disclosure to obtain a synthetic image of the target part.

In some embodiments, the scenario may further include a server. The server is a service point that provides functions such as data processing and a database. The server may be an integrated server or a decentralized server crossing a plurality of computers or computer data centers. The server may include hardware, software, an embedded logical component or a combination of two or more such components configured to perform an appropriate function supported or implemented by the server. The server is, for example, a blade server or a cloud server, or may be a server group including a plurality of servers.

The terminal device may communicate with the server through a wired network or a wireless network. In this embodiment of this disclosure, the server may perform part of the functions of the foregoing terminal device.

For example, the landmark of the target part may be uploaded to the server through the terminal device. The server processes the landmark through the image synthesis method provided in this embodiment of this disclosure to obtain a synthetic image of the target part, and then the terminal device outputs the synthetic image.

An application scenario of the image synthesis method provided in the embodiments of this disclosure is described in detail by using an example in which the image synthesis method provided in the embodiments of this disclosure is executed by a terminal in a digital human scenario.

Specifically, face driving is performed on digital human. The terminal device obtains a landmark of the target part such as a face, for example, contours corresponding to a face contour, eyes, a lip, a nose, or the like, and performs spatial structure encoding on the obtained landmark to obtain a spatial structure feature of the landmark. Further, a sampling point is determined based on a target pose of a photographing device established in the terminal device and a pixel in a preview image presented by the photographing device, and a position feature of the sampling point is determined. Finally, a synthetic image of the target part such as the face is obtained according to the spatial structure feature of the landmark and the position feature of the sampling point.

FIG. 3 is a schematic diagram of an application scenario according to an embodiment of this disclosure. Types of devices and quantities of the devices included in FIG. 3 are not limited in this embodiment of this disclosure. For example, the application scenario shown in FIG. 3 may further include a data storage device, configured to store service data. The data storage device may be an external memory, or may be an internal memory integrated in the terminal device or the server.

Technical solutions in the aspects of this disclosure are described below in further detail. The following aspects may be combined with each other, and the same or similar concepts or processes may not be described repeatedly in some aspects. The aspects of this disclosure will be described with reference to the drawings.

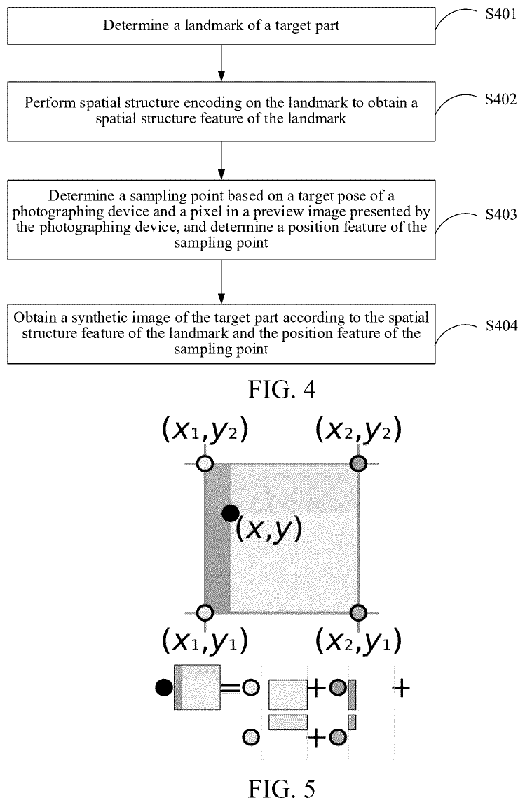

FIG. 4 is a schematic flowchart of an image synthesis method according to an embodiment of this disclosure. This embodiment of this disclosure is executed by the foregoing terminal device or server. As shown in FIG. 4, the image synthesis method includes the following operations:

S401: Determine a landmark of a target part.

For example, the target part may be a face, or may be another part in a human body, such as a limb. In the image synthesis method provided in this embodiment of this disclosure, the target part is not limited, and the target part may be determined according to an actual requirement for image synthesis.

For example, the landmark may be a 2D landmark, or may be a 3D landmark. When the target part is a face, the landmark of the face usually includes contours corresponding to a face contour, eyes, a lip, a nose, or the like.

For example, landmarks of the face may alternatively be described as landmarks. For example, the landmarks may be configured for describing the contours corresponding to the face contour, the eyes, the lip, the nose, and the like. For example, there may be 68 2D landmarks of the face. In the image synthesis method provided in this embodiment of this disclosure, a quantity of the landmarks of the target part is not limited, and the quantity of the landmarks may be determined according to an actual requirement of image synthesis.

A mode of determining the landmarks of the target part is described below in further detail.

In an example, an audio signal for indicating image synthesis is obtained, and the audio signal is mapped to the landmark of the target part. For example, the audio signal is an audio signal including the target part. For example, when the target part is a face, the audio signal may be a 5-min talking head video.

The audio signal is mapped to the landmark of the target part. For example, the audio signal may be mapped to the landmark of the target part through a preset mapping model.

In an example, landmark extraction is performed on a photographed image including the target part through a landmark extraction model to obtain the landmark of the target part. For example, the photographed image may be an image photographed through a camera. In the image synthesis method provided in this embodiment of this disclosure, an image may be synthesized based on an audio signal, or image synthesis may be performed based on an image photographed by a photographing device.

S402: Perform spatial structure encoding on the landmark to obtain a spatial structure feature of the landmark.

In some embodiments, the landmark is input to a landmark grid encoder for performing hash grid encoding to obtain a spatial structure feature vector of the landmark output by the landmark grid encoder, and further, the spatial structure feature vector of the landmark is input to an MLP for performing spatial structure feature extraction to obtain the spatial structure feature of the landmark.

There is a one-to-one correspondence between the spatial structure feature vector of the landmark and the landmark, that is, each landmark corresponds to one spatial structure feature vector of the landmark.

An example in which the landmark grid encoder performs hash encoding on the landmark to obtain the spatial structure feature vector of the landmark is described below in further detail.

Specifically, after each landmark is input to the landmark grid encoder as a query coordinate (x, y), a distance between the query coordinate and a neighboring point is calculated, the distance is used as a weight, linear combination is performed on the distance and a feature vector of the neighboring point to obtain a vector corresponding to the query coordinate, and the vector corresponding to the query coordinate is used as the spatial structure feature vector of the landmark.

FIG. 5 is a schematic diagram of performing hash encoding on a landmark by using a landmark grid encoder according to an embodiment of this disclosure. As shown in FIG. 5, a point (X, Y) represents a query coordinate, and a point (X1, Y1), a point (X1, Y2), a point (X2, Y1), and a point (X2, Y2) represent coordinates corresponding to neighboring points corresponding to the query coordinate.

The neighboring points are obtained by separately performing rounding down and rounding up on an X coordinate value and a Y coordinate value of the query coordinate.

For example, if the query coordinate is (0, 1), the X coordinate value 0 is rounded down to 0 and is rounded up to 1, and the Y coordinate value 1 is rounded down to 0 and is rounded up to 2, four neighboring points may be obtained, and coordinates of the neighboring points are respectively (0, 0), (0, 2), (1, 0), and (1, 2).

An array, for example, (m, n, l), (not shown in the figure) is set at coordinate positions of the neighboring points.

Specifically, the spatial structure feature vector corresponding to the query coordinate may be represented through the following formula:

$$T = \frac{bW 1 + cW 2 + dW 3 + eW 4}{b + c + d + e}$$

where T represents a vector corresponding to the query coordinate, b, c, d, and e respectively represent linear distances between the query coordinate and the coordinates of the neighboring points, and W1, W2, W3, and W4 respectively represent arrays corresponding to the coordinate positions of the neighboring points.

S403: Determine a sampling point based on a target pose of a photographing device and a pixel in a preview image presented by the photographing device, and determine a position feature of the sampling point.

For example, the photographing device may be a camera.

For example, the preview image may be a virtual image presented by the photographing device, or may be a real image photographed by the photographing device.

For example, the target pose may include a target position and a target observation viewpoint direction.

For example, the preview image includes a plurality of pixels, each pixel corresponds to a ray, and each ray may include at least one sampling point.

For example, the position feature of the sampling point may be a spatial position (x, y, z) of the sampling point in 3D space.

In an example, for each pixel in the preview image, a ray corresponding to each pixel is determined by using the target position of the photographing device as a start point in an observation direction of the target position for each pixel in the preview image, and sampling is performed on the ray in the 3D space to obtain the sampling point and the position feature of the sampling point.

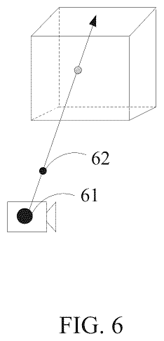

A mode of determining a sampling point is described below in further detail with reference to FIG. 6.

FIG. 6 is a schematic diagram of determining a sampling point according to an embodiment of this disclosure. As shown in FIG. 6, a black dot 61 in the figure represents a target position of a photographing device, a black dot 62 represents any pixel in a preview image presented by the photographing device, a black line with an arrow represents a ray corresponding to the pixel of the black dot 62, and a gray dot represents a sampling point obtained by sampling the ray in 3D space.

It can be learned from FIG. 6 that, the ray corresponding to the pixel is obtained by using the target position of the photographing device as a start point in an observation direction of the pixel in the preview image presented in the photographing device, and sampling is performed on the ray in the 3D space to obtain a sampling point and a spatial position of the sampling point in the 3D space. The spatial position is a position feature of the sampling point.

For example, a connection line between each pixel and a camera is the ray corresponding to the pixel.

When sampling is performed on the ray in the 3D space, one ray may have a plurality of sampling points, or may have one sampling point. In the image synthesis method provided in this embodiment of this disclosure, a quantity of sampling points on a same ray is not limited.

Each pixel in the image includes at least one sampling point.

S404: Obtain a synthetic image of the target part according to the spatial structure feature of the landmark and the position feature of the sampling point.

In an example, after concatenating processing is performed on the spatial structure feature of the landmark and the position feature of the sampling point, the spatial structure feature of the landmark and the position feature of the sampling point are input to an MLP in a NeRF model to obtain color information and density information of the sampling point that are output by the MLP. Further, voxel rendering processing is performed on the color information and the density information of the sampling point to obtain the synthetic image of the target part.

In an example of performing voxel rendering processing on the color information and the density information of the sampling point to obtain the synthetic image of the target part is described below by using a sampling point on one ray as an example.

In an example, integration processing is performed on the color information of the sampling point by using the density information of the sampling point as a weight, to obtain a pixel value corresponding to the ray, and the synthetic image is obtained according to the pixel value corresponding to each ray.

For example, the synthetic image may be a 3D implicit image.

For example, when the landmark of the target part is obtained by processing an audio signal, the synthetic image of the target part may be an audio-driven synthetic 3D implicit image.

In this embodiment of this disclosure, the landmark of the target part is determined, spatial structure encoding is performed on the landmark to obtain the spatial structure feature of the landmark, a sampling point is determined based on a target pose of the photographing device and the pixel in the preview image presented by the photographing device, the position feature of the sampling point is determined, and the synthetic image of the target part is obtained according to the spatial structure feature of the landmark and the position feature of the sampling point. In this embodiment of this disclosure, spatial structure encoding is performed by directly using the spatial structure of the landmark of the target part as an encoding object without an additional feature extraction operation such as smoothing or compression, to avoid loss of information of the target part and to achieve lossless encoding, so that accuracy and completeness of a spatial structure control feature of the landmark can be improved. Further, the spatial structure feature of the landmark is configured for obtaining the synthetic image of the target part, thereby improving fidelity of the synthetic image.

In some embodiments, a mode of determining the landmark of the target part is as follows: when an audio signal configured for indicating image synthesis is obtained and the audio signal is mapped to the landmark of the target part, spatial structure encoding is directly performed on the landmark to obtain the spatial structure feature of the landmark, so that the obtained spatial structure feature of the landmark is highly decoupled from an emotion, a gender, a language corresponding to the audio signal, thereby avoiding impact of factors such as the emotion, the gender, and the language corresponding to the audio signal on the spatial structure feature of the landmark, and ensuring accuracy of the obtained spatial structure feature of the landmark.

In some embodiments, in operation S402, spatial structure encoding is performed on the landmark to obtain the spatial structure feature of the landmark. In an example, hash grid encoding is performed on the landmark to obtain the spatial structure feature of the landmark.

For example, the landmark is input to a landmark grid encoder for performing hash grid encoding to obtain the spatial structure feature of the landmark output by the landmark grid encoder.

The hash grid encoding is performed on the landmark to obtain the spatial structure feature of the landmark, in some embodiments, for each neighboring point of the landmark, a distance between the landmark and the neighboring point is calculated, and the distance is used as a weight of the landmark and the neighboring point. A linear combination is performed on a spatial structure feature of the neighboring point of the landmark according to the weight of the landmark and each neighboring point to obtain the spatial structure feature of the landmark.

In an example is similar to the foregoing, and details are not described herein again.

In some embodiments, when a quantity of landmarks of the target part is N, in operation S402, spatial structure encoding is performed on the landmark to obtain the spatial structure feature of the landmark. In an example, for each of the N landmarks, spatial structure encoding is performed on the landmark to obtain the spatial structure feature of the landmark. Concatenating processing is performed on N spatial structure features of the N landmarks to obtain a first concatenating feature. Spatial structure feature extraction is performed on the first concatenating feature to obtain the spatial structure feature of the landmark.

For example, the first concatenating feature is input to the MLP for performing spatial structure feature extraction to obtain the spatial structure feature of the landmark output by the MLP.

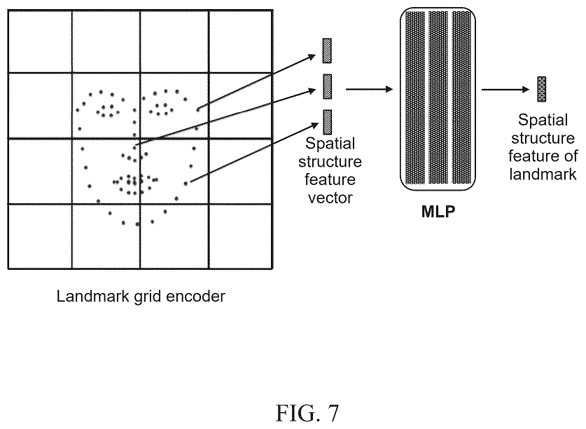

For ease of understanding, a process of extracting the spatial structure feature of the landmark is described with reference to FIG. 7 by using an example in which a face is the target part and the landmark is a 2D landmark.

FIG. 7 is a schematic diagram of extracting a spatial structure feature of a landmark based on a 2D landmark according to an embodiment of this disclosure. As shown in FIG. 7, the 2D landmark is input to a landmark grid encoder for performing hash encoding to obtain a spatial structure feature vector corresponding to the 2D landmark output by the landmark grid encoder. Further, the spatial structure feature vector is input to an MLP for performing spatial structure feature extraction to obtain the spatial structure feature of the landmark output by the MLP.

It can be learned from FIG. 7 that, the face has 68 2D landmarks in total, that is, the landmark grid encoder outputs 68 spatial structure feature vectors. Further, after spatial structure feature vectors are serially concatenated and input to the MLP, and spatial structure feature extraction is performed through the MLP to obtain the spatial structure features of the landmarks output by the MLP.

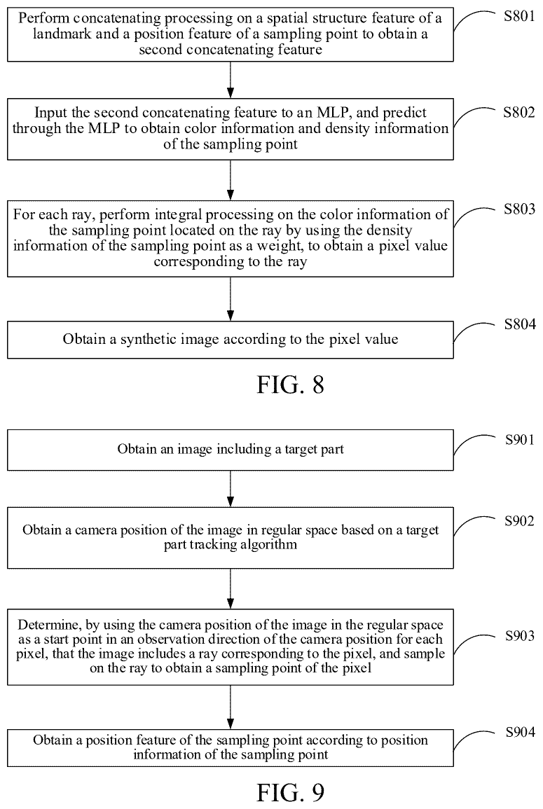

In an example of operation S404 of obtaining a synthetic image of the target part according to the spatial structure feature of the landmark and the position feature of the sampling point is described below in detail with reference to FIG. 8.

FIG. 8 is a schematic flowchart of an image synthesis method according to still another embodiment of this disclosure. As shown in FIG. 8, an example of obtaining a synthetic image of the target part according to the spatial structure feature of the landmark and the position feature of the sampling point includes the following operations:

S801: Perform concatenating processing on a spatial structure feature of a landmark and a position feature of a sampling point to obtain a second concatenating feature.

For example, the spatial structure feature of the landmark may include a spatial position of the landmark, and the position feature of the sampling point may include a spatial position of the sampling point in 3D space.

For example, concatenating processing is performed on the spatial structure feature of the landmark and the position feature of the sampling point according to the spatial position of the landmark and the spatial position of the sampling point to obtain a second concatenating feature.

S802: Input the second concatenating feature to an MLP, and predict through the MLP to obtain color information and density information of the sampling point.

The second concatenating feature includes at least one sampling point. The second concatenating feature is input to the MLP, so that the color information and the density information that are output by the MLP and that correspond to each sampling point.

S803: For each ray, perform integration processing on the color information of the sampling point located on the ray by using the density information of the sampling point as a weight, to obtain a pixel value corresponding to the ray.

Sampling is performed on each ray in the 3D space to obtain at least one sampling point, that is, each ray corresponding to each pixel may include at least one sampling point, that is, each pixel may correspond to at least one sampling point.

For each ray, integration processing is performed on the color information of the sampling point located on the ray by using the density information of the sampling point as the weight, to obtain a pixel value corresponding to the ray, that is, a pixel value of each pixel in a to-be-synthesized image corresponding to the ray.

S804: Obtain a synthetic image according to the pixel value.

In this embodiment of this disclosure, concatenating processing is performed on the spatial structure feature of the landmark and the position feature of the sampling point to obtain the second concatenating feature, the second concatenating feature is input to a multi-layer perceptron, the multi-layer perceptron predicts to obtain the color information and the density information of the sampling point, for each ray, integration processing is performed on the color information of the sampling point located on the ray by using the density information of the sampling point as the weight, to obtain the pixel value corresponding to the ray, and the synthetic image is obtained according to the pixel value, thereby improving fidelity of the synthetic image.

A mode of obtaining the position feature of the sampling point is described below in detail with reference to FIG. 9.

FIG. 9 is a flowchart of a mode of obtaining a position feature of a sampling point according to an embodiment of this disclosure. As shown in FIG. 9, a mode of obtaining the position feature of the sampling point includes the following operations:

S901: Obtain an image including a target part.

For example, the image of the target part may be one or more frames of images photographed by a photographing device, or may include one or more frames of images in a video of the target part.

S902: Obtain a camera position of the image in regular space based on a target part tracking algorithm.

For example, a position change of the target part in the image is analyzed based on the target part tracking algorithm and with reference to a camera internal parameter and a camera external parameter, so that the camera position and a camera pose of the image in the regular space may be calculated.

For example, the camera internal parameter may include a focal length, a pixel offset, a focus mode, and the like. The camera external parameter may include a camera position, a translation matrix, a rotation matrix, and the like.

S903: Determine, by using the camera position of the image in the regular space as a start point in an observation direction of the camera position for each pixel, that the image includes a ray corresponding to the pixel, and sample on the ray to obtain a sampling point of the pixel.

Examples are similar to the foregoing, and details are not described herein again.

The camera position, the observation direction of the camera position for each pixel, the ray, and the sampling point are shown in FIG. 6, and details are not described herein again.

Each pixel in the image corresponds to one ray, and one ray may include at least one sampling point. That is, one pixel may correspond to at least one sampling point.

S904: Obtain a position feature of the sampling point according to position information of the sampling point.

For example, the position information of the sampling point may be a spatial position coordinate (x, y, z) of the sampling point in 3D space.

For example, the spatial position coordinate (x, y, z) of the sampling point in the 3D space is used as the position feature of the sampling point.

In this embodiment of this disclosure, the image including the target part is obtained, the camera position of the image in the regular space is obtained based on the target part tracking algorithm, the ray corresponding to the pixel in the image is determined by using the camera position of the image in the regular space as a start point in an observation direction of the camera position for each pixel, sampling is performed on the ray to obtain a sampling point of the pixel, a position feature of the sampling point is obtained according to position information of the sampling point, and the position feature of the sampling point is configured for image synthesis of the target part, thereby improving an image synthesis effect.

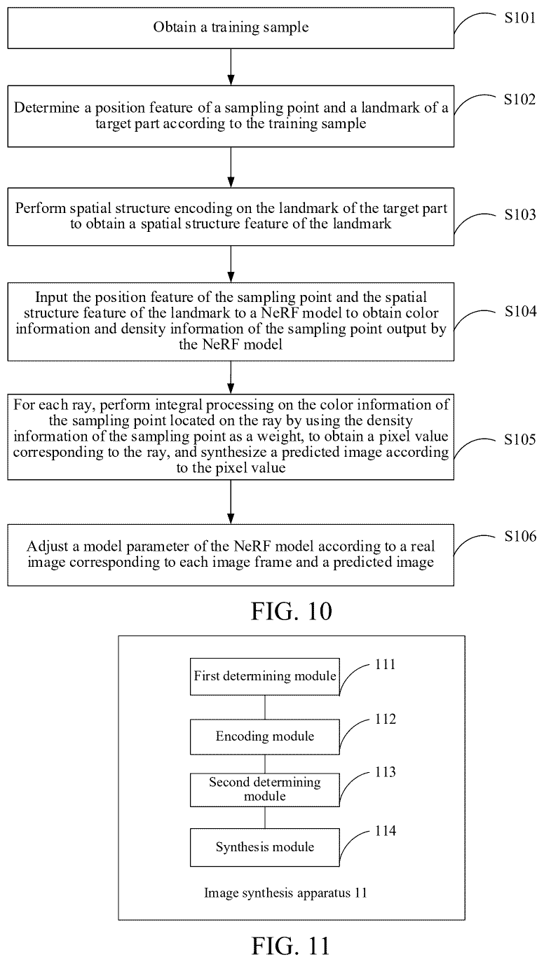

In the embodiment shown in FIG. 9, the obtained position feature of the sampling point may alternatively be configured for training a NeRF model for synthesizing an image. Training of the NeRF model used in the image synthesis method provided in this embodiment of this disclosure is described below in detail with reference to FIG. 10.

FIG. 10 is a flowchart of a NeRF model training method according to an embodiment of this disclosure. As shown in FIG. 10, the training method includes the following operations:

S101: Obtain a training sample.

For example, using an example in which the target part is a face, the training sample may be a sample talking head video including the face.

For example, the sample talking head video may be a 5-min talking head video.

S102: Determine a position feature of a sampling point and a landmark of a target part according to the training sample.

The position feature of the sampling point is determined according to the training sample. In an example, a camera position of each image frame in the sample talking head video in the regular space is obtained according to the sample talking head video based on the face tracking algorithm. The ray corresponding to each pixel in the image frame is determined by using the camera position as a start point in a direction of the camera position for each pixel in the image frame. Further, 3D spatial sampling is performed on the ray to obtain the sampling point and the position feature corresponding to the sampling point in the 3D space.

For example, the ray corresponding to each pixel in the image frame may be a connecting line between the camera position and the pixel.

The landmark of the target part is determined according to the training sample. In an example, segmentation processing is performed on audio synchronized to the sample talking head video at a preset audio sampling rate to obtain the audio corresponding to each image frame. Mapping processing is performed on audio corresponding to each image frame to obtain the landmark of the face corresponding to the audio.

For example, the preset audio sampling rate may be 40 ms.

S103: Perform spatial structure encoding on the landmark of the target part to obtain a spatial structure feature of the landmark.
is the spatial structure encoding may be performed in a manner similar to the foregoing, and details are not described herein again.

S104: Input the position feature of the sampling point and the spatial structure feature of the landmark to a NeRF model to obtain color information and density information of the sampling point output by the NeRF model.

For example, the NeRF model outputs the color information and the density information of each sampling point.

S105: For each ray, perform integration processing on the color information of the sampling point located on the ray by using the density information of the sampling point as a weight, to obtain a pixel value corresponding to the ray, and synthesize a predicted image according to the pixel value.

S106: Adjust a model parameter of the NeRF model according to a real image corresponding to each image frame and a predicted image.

In some embodiments, a pixel difference between the real image corresponding to each image frame and the predicted image is calculated, and the model parameter of the NeRF model is adjusted according to the pixel difference.

In the NeRF model provided in this embodiment of this disclosure, when the model is trained, a loss function of the NeRF model may be the pixel difference between the real image and the predicted image.

In this embodiment of this disclosure, spatial structure encoding is performed by directly using a spatial structure of the landmark of the target part as an encoding object, so that an obtained spatial structure control feature of the landmark is highly decoupled from an emotion, a gender, a language type, and the like corresponding to an audio signal including the target part. Further, the NeRF model is trained based on the spatial structure feature of the landmark, thereby improving a generalization capability of a trained NeRF model.

In some embodiments, the NeRF model training method used in image synthesis may include the following operations:

S1: Obtain a 5-min talking head video, and calculate a camera pose of each head image frame in the video in regular space through a face tracking algorithm.

S2: Obtain a pixel of each head image frame and a ray corresponding to the pixel according to the camera pose, and sample a spatial position (x, y, z) on the corresponding ray and an observation viewpoint direction (θ, φ) from 3D space according to the ray.

S3: Map driving audio to audio for driving 3D facial landmarks, that is, audio obtained by performing segmentation processing on the audio synchronized to the talking head video.

S4: Encode the 3D facial landmarks through a landmark grid encoder to obtain a condition feature vector corresponding to each 3D facial landmark, and obtain a condition control feature output by the MLP network after further processing the conditional feature vector through an MLP network.

S5: After performing corresponding concatenating on the condition control feature and position features obtained by encoding the spatial position (x, y, z) by a NeRF model, and inputting the condition control feature and position features to the NeRF model for processing, obtain color (RGB) information and density information of a sampling point output by the NeRF model.

S6: After performing integration on the color information (RGB) and the density information in a ray direction, that is, the observation viewpoint direction (θ, φ), obtain a final pixel value in the ray direction, and after calculating pixel values corresponding to all rays of a camera, obtain a predicted image result corresponding to the audio at the camera position.

S7: After calculating a pixel difference between the predicted image result and the real image, perform back propagation, and update a model parameter of the NeRF model.

The following describes apparatus embodiments of this disclosure, which can be configured to execute the method embodiments of this disclosure. For details not disclosed in the apparatus embodiments of this disclosure, reference can be made to the method embodiments of this disclosure.

FIG. 11 is a schematic structural diagram of an image synthesis apparatus according to an embodiment of this disclosure. The image synthesis apparatus 11 may be implemented in a mode of software and/or hardware. During an application, the image synthesis apparatus 11 may be integrated into the terminal device or the server as described above.

As shown in FIG. 11, the image synthesis apparatus 11 includes: a first determining module 111, an encoding module 112, a second determining module 113, and a synthesis module 114.

The first determining module 111 is configured to determine a landmark of a target part.

The encoding module 112 is configured to perform spatial structure encoding on the landmark to obtain a spatial structure feature of the landmark.

The second determining module 113 is configured to determine a sampling point based on a target pose of a photographing device and a pixel in a preview image presented by the photographing device, and determine a position feature of the sampling point.

The synthesis module 114 is configured to obtain a synthetic image of the target part according to the spatial structure feature of the landmark and the position feature of the sampling point.

In an example, the encoding module 112 is specifically configured to: perform hash grid encoding on the landmark to obtain the spatial structure feature of the landmark.

In an example, the encoding module 112 is further configured to: for each neighboring point of the landmark, calculate a distance between the landmark and the neighboring point, and use the distance as a weight of the landmark and the neighboring point; and
perform a linear combination on a spatial structure feature of the neighboring point of the landmark according to the weight of the landmark and each neighboring point to obtain the spatial structure feature of the landmark.

In an example, when a quantity of landmarks is N, the encoding module 112 is further configured to: for each of the N landmarks, perform spatial structure encoding on the landmark to obtain the spatial structure feature of the landmark; perform concatenating processing on N spatial structure features of the N landmarks to obtain a first concatenating feature; and perform spatial structure feature extraction on the first concatenating feature to obtain the spatial structure feature of the landmark.

In an example, a first determining module 111 is specifically configured to: obtain an audio signal configured for indicating image synthesis, and map the audio signal to the landmark of the target part; or, perform landmark extraction on a photographed image including the target part through a landmark extraction model to obtain the landmark of the target part.

In an example, the position feature of the sampling point is obtained in the following mode: obtaining an image including the target part; obtaining a camera position of the image in regular space based on a target part tracking algorithm; determining, by using the camera position of the image in regular space as a start point in an observation viewpoint direction of the camera position for each pixel, that the image includes a ray corresponding to the pixel, and sampling on the ray to obtain a sampling point of the pixel; and obtaining the position feature of the sampling point according to position information of the sampling point.

In an example, the synthesis module 114 is specifically configured to: perform concatenating processing on the spatial structure feature of the landmark and the position feature of the sampling point to obtain a second concatenating feature; and input the second concatenating feature into a multi-layer perceptron, and predict through the multi-layer perceptron to obtain color information and density information of the sampling point; for each ray, perform integration processing on the color information of the sampling point located on the ray by using the density information of the sampling point as a weight, to obtain a pixel value corresponding to the ray; and obtain the synthetic image according to the pixel value.

The image synthesis apparatus 11 according to this embodiment of this disclosure may be applied to technical solutions in the embodiments shown in the foregoing image synthesis method. Examples and technical effects of the apparatus and the method are similar, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

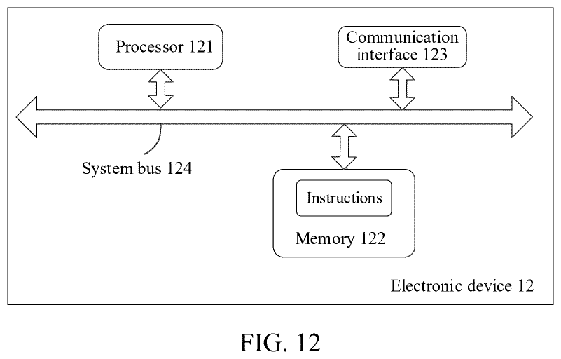

FIG. 12 is a schematic structural diagram of an electronic device according to an embodiment of this disclosure. As shown in FIG. 12, electronic device 12 include: a processor 121, a memory 122, a communications interface 123, and a system bus 124.

The memory 122, such as a non-transitory computer-readable storage medium, and the communications interface 123 are connected to the processor 121 through the system bus 124 and complete mutual communication. The memory 122 is configured to store program instructions. The communications interface 123 is configured to communicate with another device. The processor 121 is configured to invoke the program instructions in the memory to perform a solution of an audio-driven image synthesis method according to the foregoing method embodiments, and/or, perform a solution of a parameter estimation network training method according to the foregoing method embodiments.

Processing circuitry, such as the processor 121 may include one or more processing units. For example: the processor 121 may be a central processing unit (e.g., CPU), or may be a digital signal processor (DSP for short), an application specific integrated circuit (ASIC for short), and the like. The general-purpose processor may be a microprocessor, or the processor may be any conventional processor or the like. Operations of method disclosed with reference to this disclosure may be directly performed and completed by using a hardware processor, or may be performed and completed by using a combination of hardware and software modules in the processor.

The memory 122 may be configured to store program instructions. The memory 122 may include a program storage area and a data storage area. The program storage area may store an operating system, an application program required by at least one function (such as a sound playback function), and the like. The data storage area may store data (such as audio data) created during use of the electronic device 12 and the like. In addition, the memory 122 may include a high speed random access memory, and may alternatively include a non-volatile memory, for example, at least one magnetic disk storage device, a flash storage device, or a universal flash storage (UFS for short). The processor 121 executes various functional applications and data processing of the electronic device 12 by running the program instructions stored in the memory 122.

The communication interface 123 may provide a wireless communication solution applied to the electronic device 12, including 2G/3G/4G/110G. The communication interface 123 may receive an electromagnetic wave through an antenna, perform processing such as filtering and amplification on the received electromagnetic wave, and transfer the received electromagnetic wave to a modem processor for demodulation. The communication interface 123 may further amplify a signal modulated by the modem processor, and convert the signal into an electromagnetic wave through an antenna to radiate the electromagnetic wave. In some embodiments, at least part functional modules of the communication interface 123 may be disposed in the processor 121. In some embodiments, the communication interface 123 and the processor 121 may be disposed in a same device.

The system bus 124 may be a peripheral component interconnect (PCI for short) bus, an extended industry standard architecture (EISA for short) bus, or the like. The system bus 124 may be classified into an address bus, a data bus, a control bus, or the like. For ease of representation, one bold line is configured for representing the bus in the figure, but this does not mean that there is only one bus or only one type of bus.

Quantities of the memories 122 and the processors 121 are not limited in this embodiment of this disclosure, and may be one or more memories 122 and processors 121. FIG. 12 is shown by using one as an example. The memory 122 may be in wired or wireless connection with the processor 121 in a plurality of modes, for example, connected through a bus. During an application, the electronic device 12 may be a computer or a mobile terminal in various forms. The computer is, for example, a laptop computer, a desktop computer, a workstation, a server, a blade server, or a mainframe computer. The mobile terminal is, for example, a personal digital assistant, a cellular phone, a smartphone, a wearable device, and other similar computing apparatuses.

The electronic device according to this disclosure may be configured to perform technical solutions in the foregoing method embodiments. Examples and technical effects of the electronic device are similar, and details are not described herein again.

An embodiment of this disclosure further provides a computer readable storage medium. The computer readable storage medium stores a computer program. The computer program, when executed, implements the image synthesis method according to any of the foregoing embodiments.

An embodiment of this disclosure further provides a computer program product, including: a computer program. The computer program, when executed by a processor, implements the image synthesis method in any of the foregoing method embodiments.

In the foregoing embodiments, the disclosed device and method may be implemented in other modes. For example, the device embodiment described above is only schematic, for example, division of modules is only logic function division, and there may be other division modes. For example, a plurality of modules may be combined or integrated into another system, or some features may be ignored or not executed. In addition, the displayed or discussed mutual couplings or direct couplings or communication connections may be direct couplings or communication connections between an apparatus and a module through some interfaces, and may be electric, mechanical, or other forms. In addition, various functional modules in various embodiments of this disclosure may be integrated into one processing module, or various modules may exist physically independently, or two or more modules may be integrated into one module. Units of the foregoing modules may be implemented in a form of hardware, or may be implemented in a form of a hardware and software functional units.

The foregoing integrated modules implemented in a form of software functional modules may be stored in a computer readable storage medium. The foregoing software functional modules are stored in a storage medium, including a plurality of instructions to enable a computer device (which may be a personal computer, a server, a network device, or the like) or a processor to perform part operations of the methods in various embodiments of this disclosure.

The foregoing storage medium may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The storage medium may be any available medium accessible to a general-purpose or dedicated computer.

Those of ordinary skill in the art may understand that: operations for implementing various of the foregoing method embodiments may be completed through programs instructing related hardware. The foregoing program may be stored in a computer readable storage medium. The program, when executed, performs operations including the foregoing method embodiments. The foregoing storage medium includes: various media that can store program instructions such as a ROM, a RAM, a magnetic disk, or an optical disk.

What is claimed is:

1. An image synthesis method, the method comprising:
determining one or more landmarks of a target image;
processing the one or more landmarks to obtain a spatial structure feature of each of the one or more landmarks;
determining a sampling point based on a position of an image capture device and a pixel in a preview of the target image provided by the image capture device;
determining a position feature of the sampling point;
mapping an audio signal to the one or more landmarks of the target image; and
generating a synthetic image of the target image according to the spatial structure feature of (i) each of the one or more landmarks, (ii) the audio signal, and (iii) the position feature of the sampling point.

2. The image synthesis method according to claim 1, wherein the processing further comprises:
performing hash grid encoding on the one or more landmarks to obtain the spatial structure feature of each of the one or more landmarks.

3. The image synthesis method according to claim 2, wherein the hash grid encoding further comprises:
calculating a distance between a first landmark of the one or more landmarks and a first neighboring point of a plurality of neighboring points of the first landmark, and setting a weight of the first landmark and the first neighboring point based on the distance; and
performing a linear combination on the spatial structure feature of the first landmark according to the weight.

4. The image synthesis method according to claim 1, wherein
a quantity of the one or more landmarks is N, and
the processing the one or more landmarks further comprises:
concatenating the spatial structure feature of each of the N landmarks to obtain a first concatenated feature; and
performing spatial structure feature extraction on the first concatenated feature to obtain the spatial structure feature of each of the N landmarks.

5. The image synthesis method according to claim 1, wherein the determining the one or more landmarks further comprises:
performing landmark extraction on the target image through a landmark extraction model to obtain the one or more landmarks of the target image.

6. The image synthesis method according to claim 1, wherein the determining the position feature further comprises:
obtaining a camera position of the target image in space based on a target tracking algorithm;
determining, based on the camera position of the target image in the space as a start point in an observation direction of the camera position for a pixel, a ray corresponding to a set of points from the start point to the pixel in the preview of the target image;
sampling the ray to obtain the sampling point of the pixel; and
obtaining the position feature of the sampling point according to position information of the sampling point.

7. The image synthesis method according to claim 6, wherein the generating the synthetic image of the target image further comprises:
concatenating the spatial structure feature of a landmark of the one or more landmarks and the position feature of the sampling point associated with the landmark to obtain a second concatenated feature;
inputting the second concatenated feature into a multi-layer perceptron, to obtain color information and density information of the sampling point associated with the landmark;
performing integration processing on the color information of the sampling point based on the density information to obtain a pixel value corresponding to the ray of the sampling point associated with the landmark; and
generating the synthetic image according to the pixel value.

8. An image synthesis apparatus, the apparatus comprising:
processing circuitry configured to
determine one or more landmarks of a target image;
process the one or more landmarks to obtain a spatial structure feature of each of the one or more landmarks;
determine a sampling point based on a position of an image capture device and a pixel in a preview of the target image provided by the image capture device;
determine a position feature of the sampling point;
map an audio signal to the one or more landmarks of the target image; and
generate a synthetic image of the target image according to the spatial structure feature of (i) each of the one or more landmarks, (ii) the audio signal, and (iii) the position feature of the sampling point.

9. The apparatus according to claim 8, wherein the processing circuitry is configured to:
perform hash grid encoding on the one or more landmarks to obtain the spatial structure feature of each of the one or more landmarks.

10. The apparatus according to claim 9, wherein the processing circuitry is configured to:
calculate a distance between a first landmark of the one or more landmarks and a first neighboring point of a plurality of neighboring points of the first landmark;
set a weight of the first landmark and the first neighboring point based on the distance; and
perform a linear combination on the spatial structure feature of the first landmark according to the weight.

11. The apparatus according to claim 8, wherein
a quantity of the one or more landmarks is N, and
the processing circuitry is configured to:
concatenate the spatial structure features of each of the N landmarks to obtain a first concatenated feature; and
perform spatial structure feature extraction on the first concatenated feature to obtain the spatial structure feature of each of the N landmarks.

12. The apparatus according to claim 8, wherein the processing circuitry is configured to:
perform landmark extraction on the target image through a landmark extraction model to obtain the one or more landmarks of the target image.

13. The apparatus according to claim 8, wherein the processing circuitry is configured to:
obtain a camera position of the target image in space based on a target tracking algorithm;
determine, based on the camera position of the target image in the space as a start point in an observation direction of the camera position for each pixel, a ray corresponding to a set of points from the start point to the pixel in the preview of the target image;
sample the ray to obtain the sampling point of the pixel; and
obtain the position feature of the sampling point according to position information of the sampling point.

14. The apparatus according to claim 13, wherein the processing circuitry is configured to:
concatenate the spatial structure feature of a landmark of the one or more landmarks and the position feature of the sampling point associated with the landmark to obtain a second concatenated feature;
input the second concatenated feature into a multi-layer perceptron, to obtain color information and density information of the sampling point associated with the landmark;
perform integration processing on the color information of the sampling point based on the density information to obtain a pixel value corresponding to the ray of the sampling point associated with the landmark; and
generate the synthetic image according to the pixel value.

15. A non-transitory computer-readable storage medium, storing instructions which when executed by a processor cause the processor to perform:
determining one or more landmarks of a target image;
processing the one or more landmarks to obtain a spatial structure feature of each of the one or more landmarks;
determining a sampling point based on a position of an image capture device and a pixel in a preview of the target image provided by the image capture device;
determining a position feature of the sampling point;
mapping an audio signal to the one or more landmarks of the target image; and
generating a synthetic image of the target image according to the spatial structure feature of (i) each of the one or more landmarks, (ii) the audio signal, and (iii) the position feature of the sampling point.

16. The non-transitory computer-readable storage medium according to claim 15, wherein the processing further comprises:
performing hash grid encoding on the one or more landmarks to obtain the spatial structure feature of each of the one or more landmarks.

17. The non-transitory computer-readable storage medium according to claim 16, wherein the hash grid encoding further comprises:
calculating a distance between a first landmark of the one or more landmarks and a first neighboring point of a plurality of neighboring points of the first landmark, and setting a weight of the first landmark and the first neighboring point based on the distance; and
performing a linear combination on the spatial structure feature of the first landmark according to the weight.

18. The non-transitory computer-readable storage medium according to claim 15, wherein
a quantity of the one or more landmarks is N, and
the processing the one or more landmarks further comprises:
concatenating the spatial structure feature of each of the N landmarks to obtain a first concatenated feature; and
performing spatial structure feature extraction on the first concatenated feature to obtain the spatial structure feature of each of the N landmarks.

19. The non-transitory computer-readable storage medium according to claim 15, wherein the determining the position feature further comprises:
obtaining a camera position of the target image in space based on a target tracking algorithm;
determining, based on the camera position of the target image in the space as a start point in an observation direction of the camera position for each pixel, a ray corresponding a set of points from the start point to the pixel in the preview of the target image;
sampling the ray to obtain the sampling point of the pixel; and
obtaining the position feature of the sampling point according to position information of the sampling point.

20. The non-transitory computer-readable storage medium according to claim 19, wherein the generating the synthetic image of the target image further comprises:
concatenate the spatial structure feature of a landmark of the one or more landmarks and the position feature of the sampling point associated with the landmark to obtain a second concatenated feature;
inputting the second concatenated feature into a multi-layer perceptron, to obtain color information and density information of the sampling point associated with the landmark;
performing integration processing on the color information of the sampling point based on the density information to obtain a pixel value corresponding to the ray of the sampling point associated with the landmark; and
generating the synthetic image according to the pixel value.
